(19) United States
(12) Patent Application Publication
(10) Pub. No.: US 2009/0129108 A1
(43) Pub. Date: May 21, 2009

(54) VEHICLE LAMP

(76) Inventor: Ming-Chang Shih, Tainan Hsien (TW)

Correspondence Address: Dr. BANGER SHIA;Int''l Patent Office of Bang Shia, 102 Lindencrest Ct, Sugar Land, TX, 77479-5201, US

(21) Appl. No.: 11/943,408

(22) Filed: Nov. 20, 2007

(51) Int. Cl. F21V 21/14

(52) U.S. Cl. 362/523

(57) ABSTRACT

A vehicle lamp includes a coupling seat mounted to a vehicle body and a lamp seat received in the lamp seat and having two ends pivotably connected to two lateral walls of the coupling seat. An elastic element is mounted between the coupling seat and the lamp seat to bias an engaging portion on one of the lateral walls of the lamp seat to engage with an engaging portion on one of the ends of the coupling seat to retain the lamp seat in an angular position relative to the coupling seat. The lamp seat is movable in the coupling seat to compress the elastic element and to disengage the engaging portion of the lamp seat from the engaging portion of the coupling seat, allowing the lamp seat to pivot to another angular position relative to the coupling seat.

### BACKGROUND OF THE INVENTION

1. Field of the Invention

The present invention relates to a vehicle lamp and, more particularly, to a vehicle lamp that can be adjusted to and reliably positioned in a desired angular illuminating position through easy operation in an economic manner.

2. Description of the Related Art

A typical vehicle lamp includes a lamp seat fixed to a vehicle body and an illuminating member mounted in the lamp seat to emit light beams through a light-transmittable shield on the lamp seat. However, the angular position of the lamp seat can not be changed after installation. Adjustment of the angular position of the lamp seat is not easy even after detachment of the lamp seat.

Vehicle lamp devices utilizing a motor to adjust the illuminating angle of the lamp have been proposed and generally include a lamp seat, an illuminating member, a control circuit, and a motor mechanism that is controlled by the control circuit to move the lamp seat or the illuminating member to change the illuminating angle. However, these lamp devices are expensive in addition to high malfunction rate of the control circuit and the motor mechanism.

### BRIEF SUMMARY OF THE INVENTION

An objective of the present invention is to provide an inexpensive vehicle lamp whose illuminating angle can be easily adjusted in an economical manner while reliably retaining the vehicle lamp in the desired angular illuminating position.

A vehicle lamp according to the preferred teachings of the present invention includes a coupling seat adapted to be mounted to a vehicle body. The coupling seat includes a compartment defined by two lateral walls. One of the two lateral walls includes an engaging portion. A lamp seat has a length smaller than that of the compartment of the coupling seat allowing the lamp seat to move in the compartment. The lamp seat includes two ends pivotably connected to the lateral walls of the coupling seat. One of the ends of the lamp seat includes an engaging portion releasably engaged with the engaging portion of the coupling seat. An illuminating member is mounted in the lamp seat. An elastic element is mounted between the other lateral wall of the coupling seat and the other end of the lamp seat to bias the engaging portion of the lamp seat to engage with the engaging portion of the coupling seat to retain the lamp seat in an angular position relative to the coupling seat. The lamp seat is movable in the compartment of the coupling seat to compress the elastic element and to disengage the engaging portion of the lamp seat from the engaging portion of the coupling seat, allowing the lamp seat to pivot to another angular position relative to the coupling seat.

Preferably, one of the engaging portions includes a plurality of annularly spaced engaging holes, and the other engaging portion includes a plurality of pegs releasably engaged with the plurality of engaging holes.

Preferably, the other end of the lamp seat includes a groove in which the elastic element is received.

In an embodiment, the lateral sides of the coupling seat include aligned axle holes. Each end of the lamp seat includes a coupling hole. Two axles are extended through the axle holes of the coupling seat into the coupling holes of the ends of the lamp seat.

In another embodiment, the lateral sides of the coupling seat include aligned axle holes, and each end of the lamp seat includes an axle rotatably engaged in one of the axle holes of the coupling seat.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows an exploded perspective view of a vehicle lamp of a first embodiment according to the preferred teachings of the present invention.

FIG. 2 shows a perspective view of the vehicle lamp of FIG. 1.

FIG. 3 shows a cross sectional view of the vehicle lamp of FIG. 1.

FIG. 4 shows a cross sectional view of the vehicle lamp of FIG. 3 with a lamp base moved to a position disengaged from a coupling seat.

FIG. 5 shows a side view of the vehicle lamp of FIG. 1 with the lamp base pivoted through an angle.

FIG. 6 shows an exploded perspective view of a vehicle lamp of a second embodiment according to the preferred teachings of the present invention.

FIG. 7 shows a cross sectional view of the vehicle lamp of FIG. 6.

All figures are drawn for ease of explanation of the basic teachings of the present invention only; the extensions of the Figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

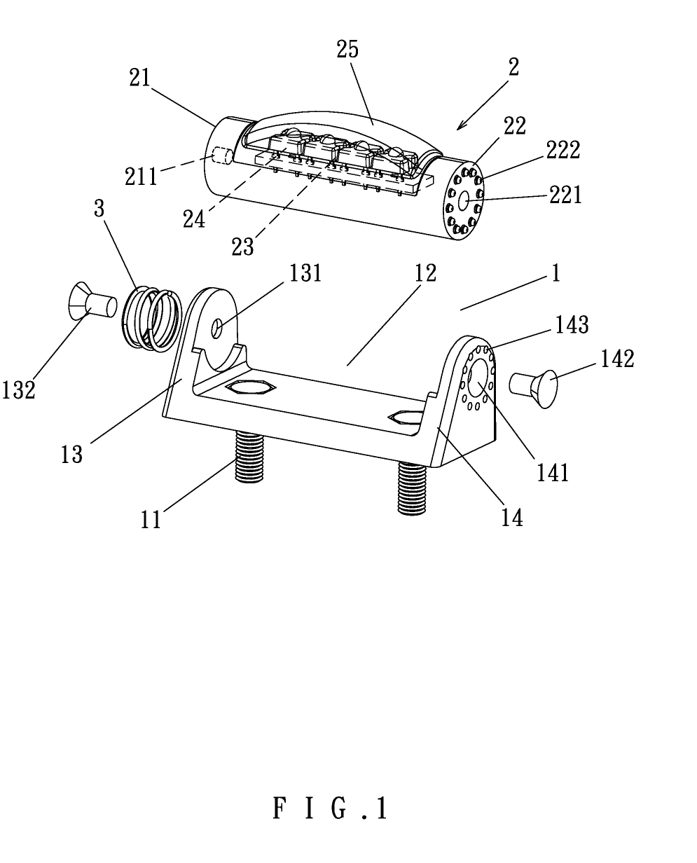

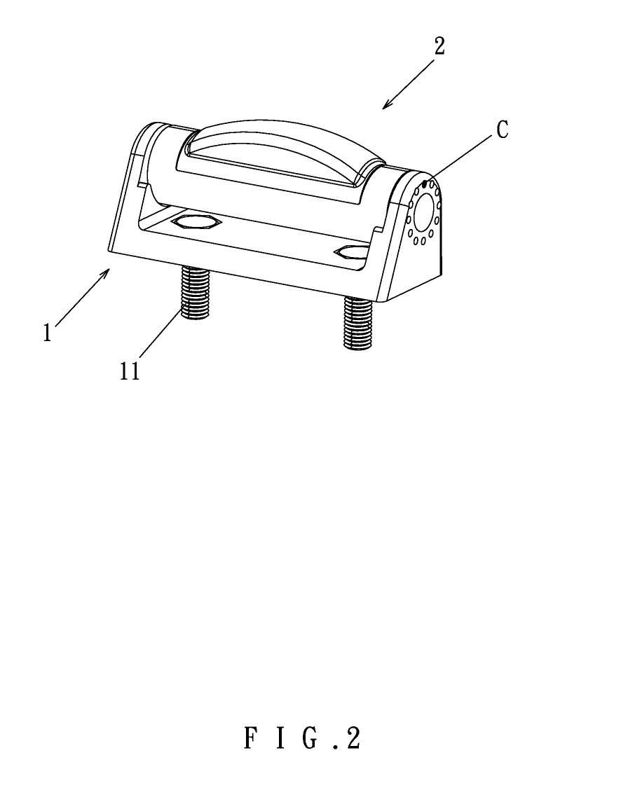

FIGS. 1-5 show a vehicle lamp of a first embodiment according to the preferred teachings of the present invention. According to the preferred form shown, the vehicle lamp includes a coupling seat 1, a lamp seat 2, and an elastic element 3. The coupling seat 11 is fixed to a vehicle body (not shown) by fasteners 11. The coupling seat 11 includes a compartment 12 defined by two lateral walls 13 and 14 having aligned axle holes 131 and 141. An axle 132, 142 is mounted in each axle hole 131, 141 by screwing or other suitable ways. An end of each axle 132, 142 is extended into the compartment 12. The lateral wall 14 includes an engaging portion 143 having a plurality of angularly spaced engaging holes.

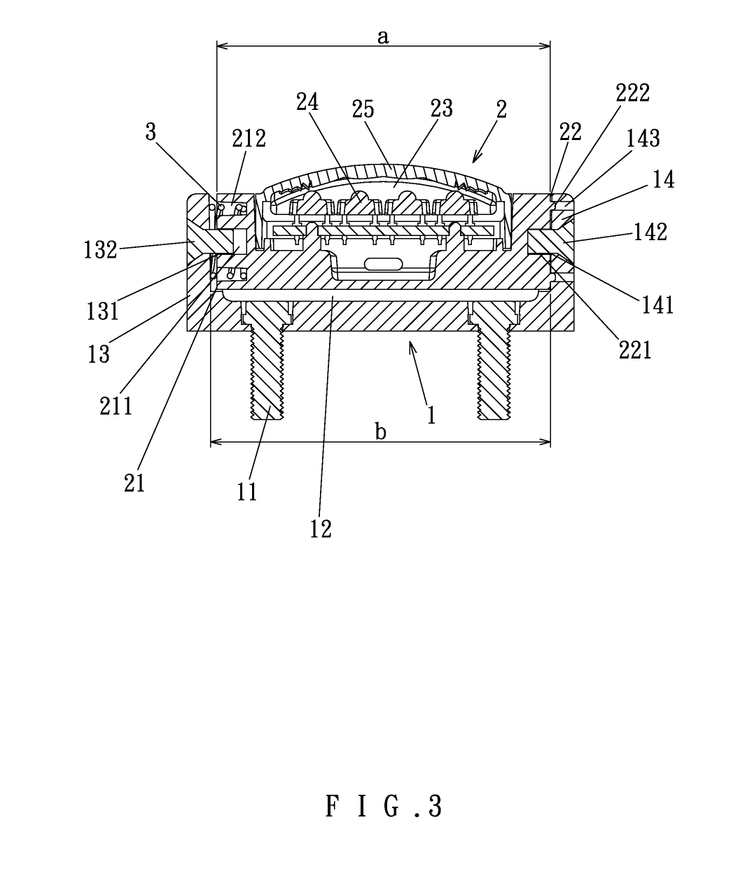

The lamp seat 2 has a length a smaller than the length b of the compartment 12 (see FIG. 3) allowing the lamp seat 2 to move in the compartment 12 in a lengthwise direction of the compartment 12. The lamp seat 2 includes two ends 21 and 22 each having a coupling hole 211, 221 engaged with one of the axles 132 and 142. The end 21 includes a groove 212 in an end face thereof for receiving the elastic element 3. The end 22 includes an engaging portion 222 having plurality of annularly spaced pegs. The lamp seat 2 further includes a compartment 23 in which an illuminating member 24 and a circuit board are mounted. The illuminating member 24 can be light-emitting diodes or other lamps that emit lights when powered by electricity. A light-transmittable shield 25 is mounted to seal the compartment 23.

The elastic element 3 is attached between the lateral wall 13 of the coupling seat 1 and the end 21 of the lamp seat 2. An end of the elastic element 3 is received in the groove 212. The pegs of the engaging portion 222 are biased by the elastic element 3 to engage with the engaging holes of the engaging portion 143 of the coupling seat 1 to retain the lamp seat 2 in a desired angular position relative to the coupling seat 1.

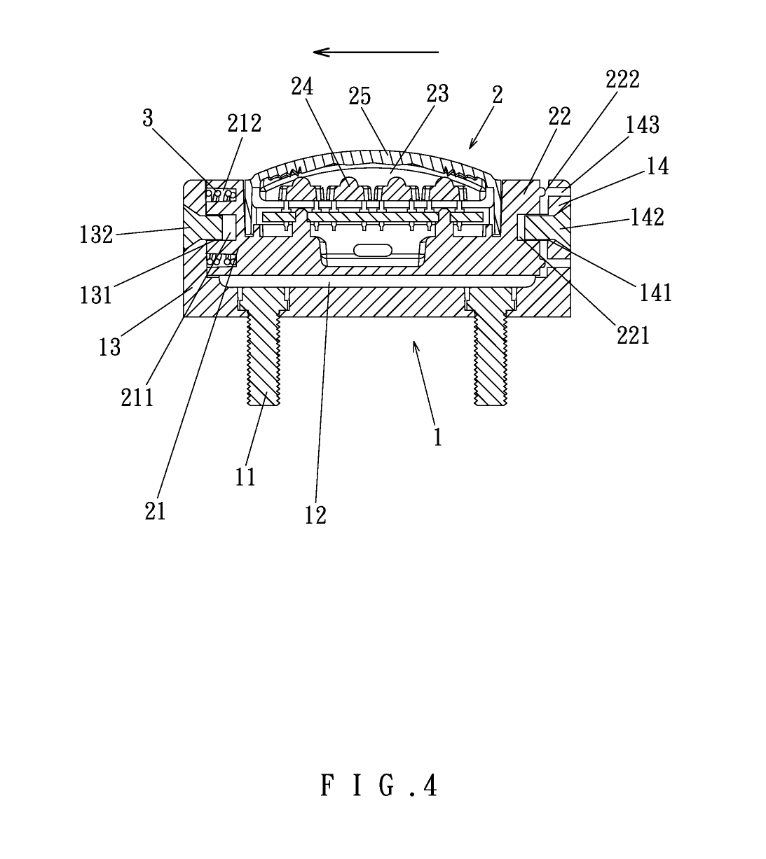

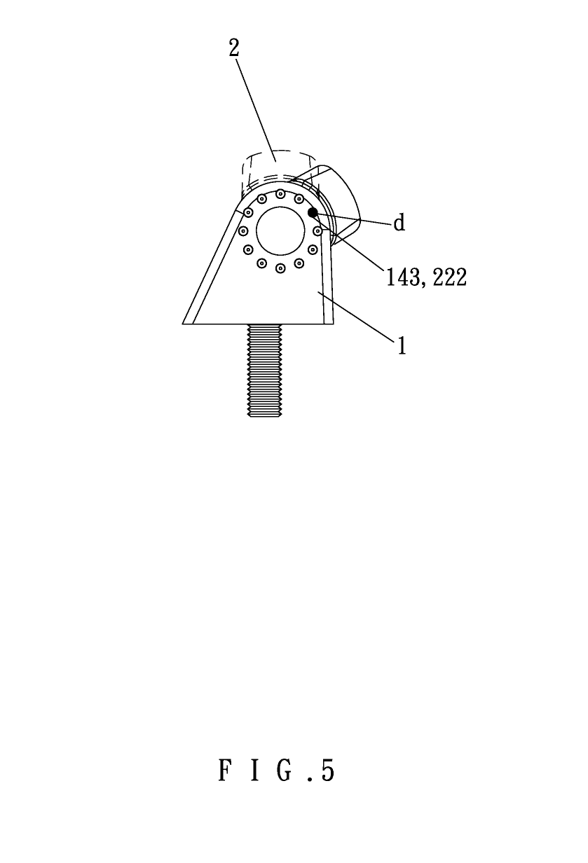

With reference to FIG. 4, the lamp seat 2 can be moved toward the elastic element 3 to compress the elastic element 3 so as to disengage the pegs of the engaging portion 222 from the engaging holes of the engaging portion 143 of the coupling seat 1. With reference to FIG. 5, the lamp seat 2 can be pivoted relative to the coupling seat 1 to a desired angular position and then released so that the pegs of the engaging portion 222 of the lamp seat 2 reengage with the engaging holes of the engaging portion 143 of the coupling seat 1 under the action of the elastic element 3 (the peg in position c in FIG. 3 is moved to position d in FIG. 5). The adjustment of the angular position of the lamp seat 2 is easy while the components of the vehicle lamp according to the preferred teachings of the present invention are inexpensive.

It can be appreciated that the engaging holes can be formed in the engaging portion 143 of the lamp seat 1, and the pegs can be formed on the engaging portion 222 of the lamp seat 2.

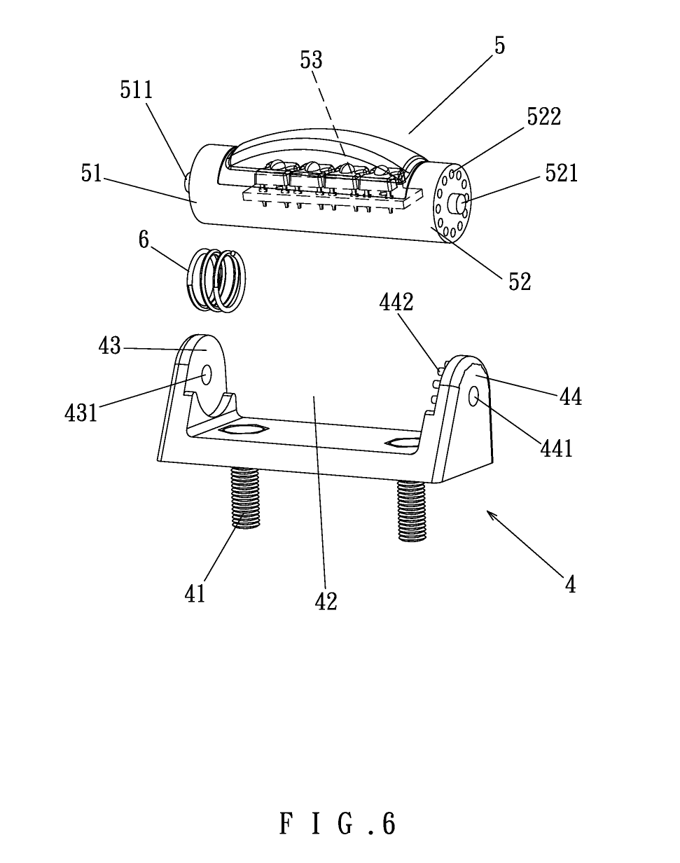

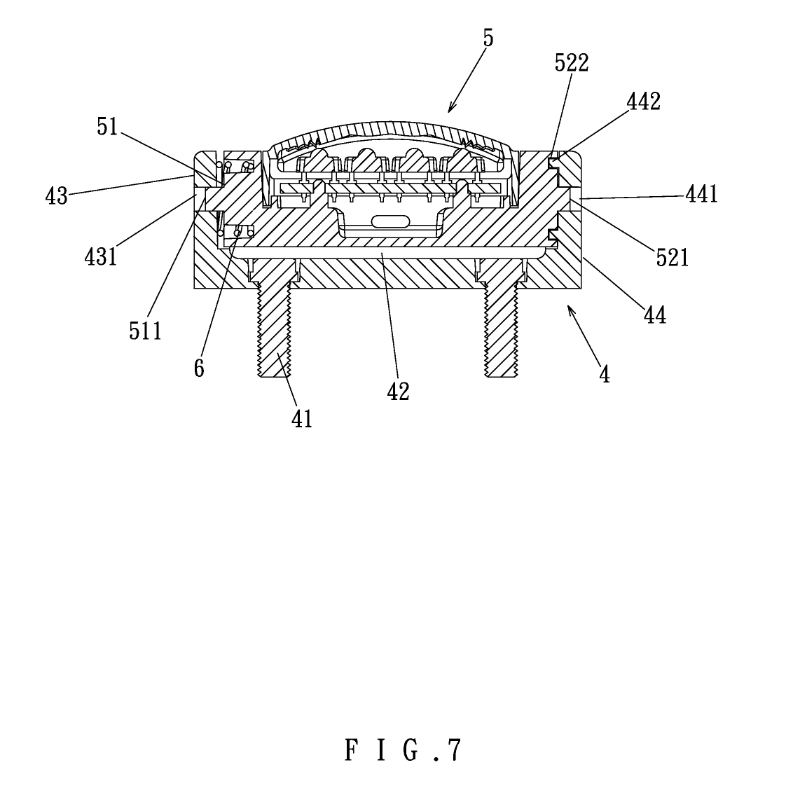

FIGS. 6-7 show a vehicle lamp of a second embodiment according to the preferred teachings of the present invention. According to the preferred form shown, the vehicle lamp includes a coupling seat 4 fixed to a vehicle body by fasteners 41, a lamp seat 5, and an elastic element 6. The coupling seat 4 includes a compartment 42 defined by two lateral walls 43 and 44 having aligned axle holes 431 and 441. The lateral wall 44 includes an engaging portion 442 having a plurality of angularly spaced pegs on an inner side thereof.

The lamp seat 5 has a length smaller than the length of the compartment 42 allowing the lamp seat 5 to move in the compartment 42 in a lengthwise direction of the compartment 42. The lamp seat 5 includes two ends 51 and 52 each having an axle 511, 521 engaged with one of the axle holes 431 and 441. The end 52 includes an engaging portion 522 having plurality of engaging holes. The lamp seat 5 further includes a compartment 53 in which an illuminating member and a circuit board are mounted. A light-transmittable shield is mounted to seal the compartment of the lamp seat 5.

The elastic element 6 is attached between the lateral wall 43 of the coupling seat 4 and the end 51 of the lamp seat 5 to bias the engaging holes of the engaging portion 522 to engage with the pegs of the engaging portion 442 of the coupling seat 4 to retain the lamp seat 5 in a desired angular position relative to the coupling seat 4.

The lamp seat 5 can be moved toward the elastic element 6 to compress the elastic element 6 so as to disengage the engaging portion 522 of the lamp seat 5 from the engaging portion 442 of the coupling seat 4. The lamp seat 5 can be pivoted relative to the coupling seat 4 to a desired angular position and then released so that the engaging holes of the engaging portion 522 of the lamp seat 5 reengage with the pegs of the engaging portion 442 of the coupling seat 4 under the action of the elastic element 6. The adjustment of the angular position of the lamp seat 5 is easy while the components of the vehicle lamp according to the preferred teachings of the present invention are inexpensive.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A vehicle lamp comprising:
a coupling seat adapted to be mounted to a vehicle body, with the coupling seat including a compartment defined by two lateral walls, with one of the two lateral walls including a first engaging portion;
a lamp seat having a length smaller than that of the compartment of the coupling seat allowing the lamp seat to move in the compartment, with the lamp seat including two ends pivotably connected to the two lateral walls of the coupling seat, with one of the two ends of the lamp seat including a second engaging portion releasably engaged with the first engaging portion of the coupling seat, with an illuminating member being mounted in the lamp seat; and
an elastic element mounted between another of the two lateral walls of the coupling seat and another of the two ends of the lamp seat to bias the second engaging portion of the lamp seat to engage with the first engaging portion of the coupling seat to retain the lamp seat in an angular position relative to the coupling seat,
with the lamp seat being movable in the compartment of the coupling seat to compress the elastic element and to disengage the second engaging portion of the lamp seat from the first engaging portion of the coupling seat, allowing the lamp seat to pivot to another angular position relative to the coupling seat.

2. The vehicle lamp as claimed in claim 1, with the first engaging portion of the coupling seat including a plurality of annularly spaced engaging holes, and with the second engaging portion of the lamp seat including a plurality of pegs releasably engaged with the plurality of engaging holes.

3. The vehicle lamp as claimed in claim 1, with the first engaging portion of the coupling seat including a plurality of annularly spaced pegs, and with the second engaging portion of the lamp seat including a plurality of engaging holes releasably engaged with the plurality of pegs.

4. The vehicle lamp as claimed in claim 1, with the two lateral sides of the coupling seat including aligned axle holes, with each of the two ends of the lamp seat including a coupling hole, with the vehicle lamp further comprising, in combination:
two axles extending through the axle holes of the coupling seat into the coupling holes of the two ends of the lamp seat.

5. The vehicle lamp as claimed in claim 1, with the other of the two ends of the lamp seat including a groove in which the elastic element is received.

6. The vehicle lamp as claimed in claim 1, with the two lateral sides of the coupling seat including aligned axle holes, and with each of the two ends of the lamp seat including an axle rotatably engaged in one of the axle holes of the coupling seat.
